(19) United States
(12) Patent Application Publication
(10) Pub. No.: US 2011/0024471 A1
(43) Pub. Date: Feb. 3, 2011

(54) CARGO BAGS

(75) Inventors: Doug Golenz, Littleton, CO (US); Chris Sautter, Portland, OR (US); John Hoppes, Hillsboro, OR (US); Bill Stephens, Boulder, CO (US)

Correspondence Address: KOLISCH HARTWELL, P.C., 200 PACIFIC BUILDING, 520 SW YAMHILL STREET, PORTLAND, OR, 97204, US

(73) Assignee: Yakima Products, Inc., Beaverton, OR (US)

(21) Appl. No.: 12/796,540

(22) Filed: Jun. 8, 2010

Related U.S. Application Data
(60) Provisional application No. 61/185,136, filed on Jun. 8, 2009.

(51) Int. Cl. B60R 9/058; B60R 9/04

(52) U.S. Cl. 224/314; 224/309

(57) ABSTRACT

Cargo bags that are mountable on a roof or roof rack of a vehicle are provided herein. In some embodiments, a cargo bag may include a container portion constructed at least partially of textile, a strap for securing the container portion to the roof or roof rack, and a structure adapted to provide shape to the container portion regardless of whether cargo is stored within the container portion. The structure may include a semi-rigid elongate member and/or foam padding. Some embodiments may include a pad positioned on a bottom of the container portion to protect the roof of the vehicle.

### CROSS-REFERENCE TO RELATED APPLICATION

This application claims priority from U.S. Provisional Patent Application Ser. No. 61/185,136, filed Jun. 8, 2009 which is incorporated herein by reference.

### BACKGROUND

Accessory cargo carriers for vehicles are becoming increasingly popular, especially as average vehicle sizes decrease in response to fuel economy and efficiency concerns. Hard shelled cargo boxes designed for mounting on a roof rack on the top of a vehicle are commonly used. Soft-shelled containers or cargo bags are also sometimes used. Hard shelled carriers retain a desired shape and may be easier to load and unload than a cargo bag. On the other hand, cargo bags may be collapsible for storage in a vehicle or dwelling. However, when not fully loaded, cargo bags tend to flap in the wind when the vehicle is moving, causing noise and possible harm to items carried inside the bag and/or the vehicle.

### SUMMARY

A cargo bag is mountable on a roof rack of a vehicle. A container portion may be constructed at least partially of fabric or textile. A strap for securing the container portion to the roof rack is provided. A structure may be adapted to provide shape to the container portion.

### BRIEF DESCRIPTION OF THE DRAWINGS

FIG. 1 depicts an exemplary cargo bag secured to a roof rack of a vehicle.

FIG. 2 depicts an exemplary cargo bag that includes a semi-rigid elongate member shaped into a frame that maintains the shape of the cargo bag regardless of whether cargo is stored therein.

FIG. 3 depicts the embodiment of FIG. 2, and shows that the frame includes a portion secured to a base of a container portion of the cargo bag, and another portion that is secured to a closure of the container portion and that is biased away from the portion secured to the base.

FIG. 4 depicts exemplary foam padding that may be used to provide shape to a cargo bag regardless of whether cargo is stored within a container portion of the cargo bag.

FIG. 5 depicts the exemplary foam padding of FIG. 4 nearly assembled.

FIG. 6 depicts the exemplary foam padding of FIGS. 4-5 as it may be assembled within a container portion of a cargo bag.

FIG. 7 depicts the foam padding of FIGS. 4-6 as it may be compressed, allowing the cargo bag to be stowed.

FIG. 8 is a partial cross sectional view of a piece of foam padding, according to an embodiment of the disclosure.

FIG. 9 depicts another exemplary cargo bag having pads on the bottom for protection of a vehicle roof and wheels for easy transport.

FIG. 10 is a bottom view of the exemplary cargo bag of FIG. 9.

FIG. 11 depicts an exemplary buckle that may be used with various embodiments of the disclosure.

FIG. 12 depicts an example of how the buckle of FIG. 11 may be used to secure a loose end of a strap to a cargo bag.

### DETAILED DESCRIPTION

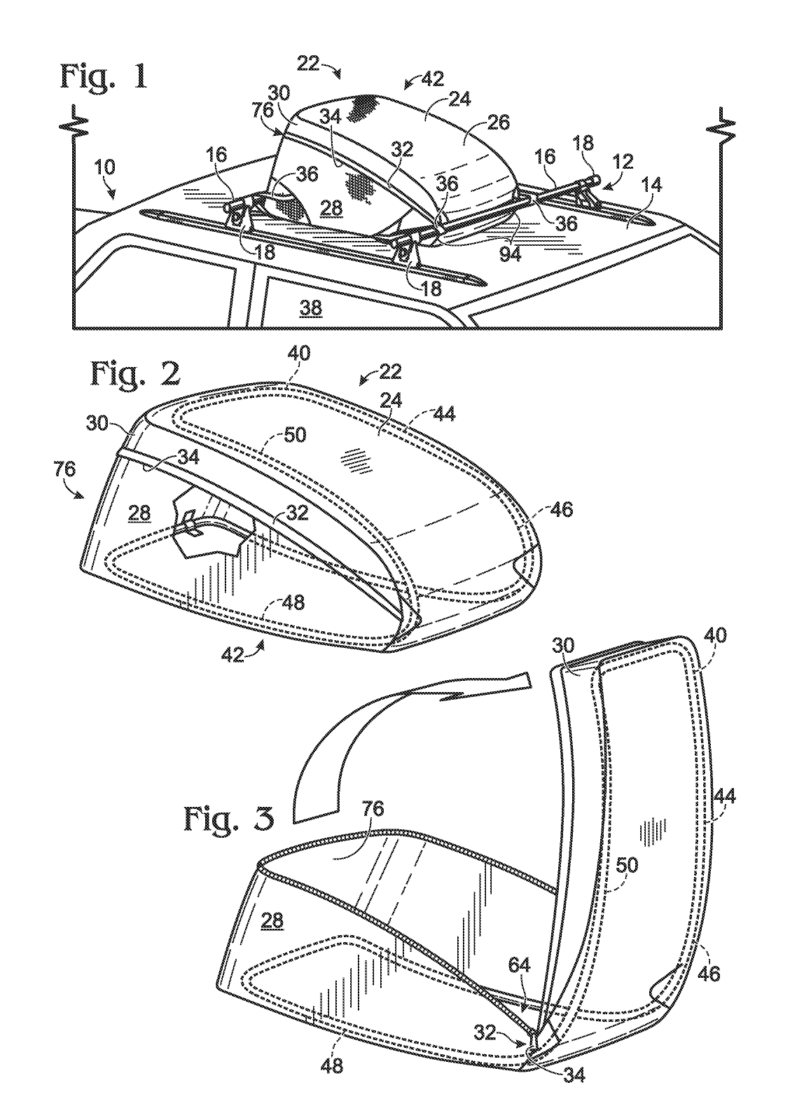

Referring now to FIG. 1, part of vehicle 10 may be seen with roof rack 12 secured to roof 14 of vehicle 10. Rack 12 includes one or more, preferably two, crossbars 16 affixed to one or more towers 18. Although a particular vehicle 10 and roof rack 12 are shown, these are not meant to be limiting, and exemplary cargo bags disclosed herein may be used with other types of vehicles and roof racks. For example, instead of the roof rack 12 shown in FIG. 1 that is typically installed outside of the factory, roof rack 12 may be a factory-installed roof rack that includes side rails in addition to or instead of crossbars 16. Additionally, cargo bags disclosed herein may be secured to vehicles without roof racks.

An exemplary soft-shelled cargo bag 22 with container portion 24 constructed at least partially out of textile 26 is secured to roof rack 12 of vehicle 10. In some embodiments, container portion 24 is almost entirely constructed with textile 26, whereas in other embodiments, some portions of container portion 24 are rigid and other portions are textile 26. Various materials may be used to construct textile 26, such as polymers. In some embodiments, textile 26 includes polyvinyl chloride (PVC), while other embodiments are PVC-free. It is generally desirable to use materials that are waterproof, or at least water resistant.

Container portion 24 includes base 28 and closure 30 with fastener 32 that is usable to secure closure 30 to base 28, thereby permitting or denying access to an interior of container portion 24. In some embodiments, such as those shown in the drawings, fastener 32 may be a zipper 34. In other embodiments, fastener 32 may include one or more buckles, Velcro, buttons, string, clips, straps among other possible fasteners.

Cargo bag 22 includes at least one strap 36 for securing container portion 24 to roof rack 12. Strap 36 may be constructed with various materials such as nylon or polypropylene. In some instances, such as where vehicle 10 does not include roof rack 12, strap 36 may be used to secure cargo bag 22 directly to roof 14. For example, strap 36 may be extended into a window 38 of vehicle 10 (which would be at least partially opened to receive strap 36), through the interior of vehicle 10, and out of an opposite window 38 (again, at least partially opened to receive strap 36).

Because container portions 24 of cargo bags 22 may be constructed at least partially of textile, cargo bags 22 may collapse when not filled with cargo. However, if cargo bag 22 is collapsed while vehicle 10 is moving, cargo bag 22 may flap about and possibly reduce fuel efficiency, and/or cause excess noise. Accordingly, cargo bag 22 may include structure 40 (see FIGS. 2-7) adapted to provide shape 42 to container portion 24 regardless of whether cargo is stored within container portion 24. Shape 42 may be configured to be aerodynamic. For example, in FIG. 1, shape 42 is shallower towards the front and deeper towards the rear, making it less wind-resistant than if it were box-shaped. In some embodiments, shape 42 mimics a shape of a hard-shelled cargo box often used on vehicles.

In some embodiments, structure 40 for maintaining shape 42 of container portion 24 may include one or more semi-rigid elongate members. For example, in FIGS. 2 and 3, a semi-rigid elongate member 44 is pre-shaped into a frame 46 that maintains shape 42 of container portion 24. Frame 46 includes a first portion 48 secured to base 28 of container portion 24 and a second portion 50 secured to closure 30 of container portion 24. As seen in FIG. 3, second portion 50 of frame 46 may be biased away from first portion 48 of frame 46 (in the direction of the arrow) so that closure 30 of container portion 24 is biased to an open position when unsecured from base 28. Frame 46 may be removable from container portion 24 to make cargo bag 22 collapsible.

Some embodiments may include multiple semi-rigid elongate members that may be assembled together to form a frame. These multiple semi-rigid elongate members may be assembled to provide shape 42 to container portion 24, similar to the manner in which tents poles are used to provide shape to a tent. In some instances, each semi-rigid elongate member may include an inner lumen so that a string can be fed through the lumens. In embodiments where shape 42 is provided by one or more semi-rigid elongate members, the semi-rigid elongate members may be removable from container portion 24 to make container portion 24 collapsible.

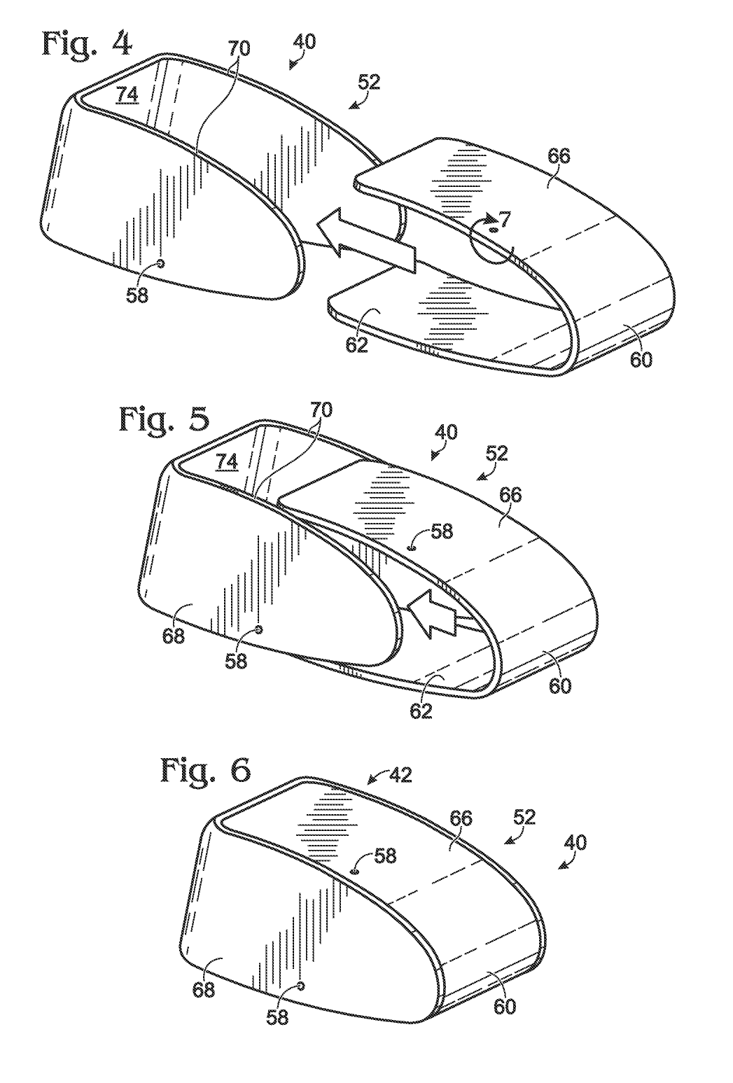

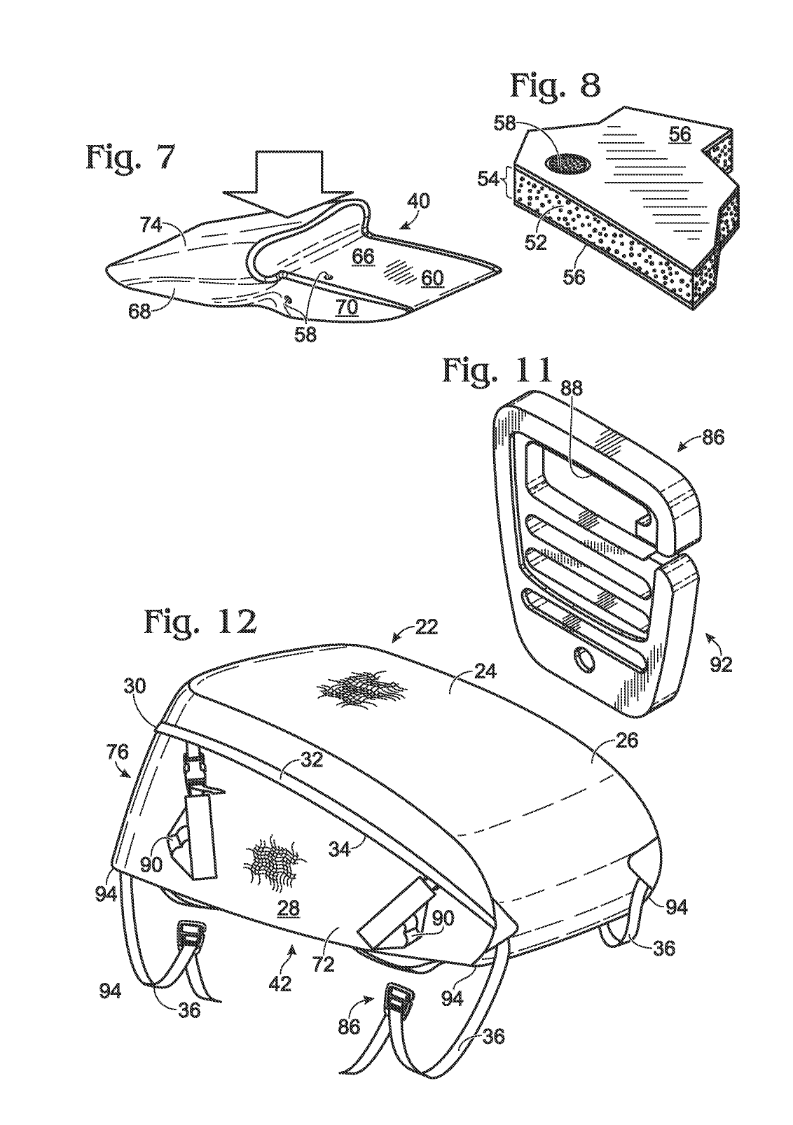

In other embodiments, structure 40 for maintaining shape 42 of container portion 24 may come in the form of foam padding. Referring now to FIGS. 4-8, foam padding 52 may be provided that has a default expanded configuration (shown in FIGS. 4-6) in which it provides shape 42 to cargo bag 22, and a contracted configuration (shown in FIG. 7) in which it allows cargo bag 22 to be stored. In some embodiments, foam padding 52 may be removable from container portion 24 altogether.

In some embodiments, foam padding 52 may be contained within an airtight chamber 54. This is seen best in FIG. 8, where foam padding 52 includes laminate 56 on its surface that makes the interior airtight, thus forming airtight chamber 54. A valve 58 may be provided that is manipulable between an open position, in which gas is permitted to pass in or out of airtight chamber 54, and a closed position, in which gas is not permitted to pass in or out of airtight chamber 54. Various types of valves may be used, and valve 58 may be positioned at various locations on cargo bag 22, such as on a side that is easily accessible, and/or on top, as shown in FIGS. 4-8.

As noted above, foam padding 52 is biased towards the expanded configuration. Accordingly, when foam padding 52 is in the contracted configuration, valve 58 may be opened to permit gas to enter airtight chamber 54. The biased nature of foam padding 52 causes it to expand, which in turn draws gas into airtight chamber 54. Thus, foam padding 52 automatically expands to provide shape 42 to container portion 24 when valve 58 is opened. In some embodiments, the natural bias of foam padding 52 towards its expanded configuration may not provide sufficient strength to structure 40. In such cases, a user may allow foam padding 52 to expand as far as possible on its own, and then the user can cause additional gas to enter airtight chamber 54 (e.g., by blowing air into valve 58), thus providing additional strength to structure 40.

In some embodiments, multiple pieces of foam padding 52 may be used to provide shape 42 to container portion 24 of cargo bag 22. Referring back to FIG. 4, a first piece 60 of foam padding 52 has a bottom portion 62 for lining a floor 64 of container portion 24 (see FIG. 3) and a top portion 66 that may be used to line closure 30 of container portion 24. A second piece 68 of foam padding 52 includes side portions 70 for lining the sides 72 (see FIGS. 1-2, 10, 12) of container portion 24 and a back portion 74 that may be used to line a back 76 (see FIGS. 1-2, 10, 12) of container portion 24. FIG. 5 depicts first and second pieces (60, 68) of foam padding 52 nearly assembled. FIG. 6 depicts first and second pieces (60, 68) of foam padding 52 entirely assembled into shape 42. FIG. 7 depicts the assembled pieces (60, 68) of foam padding 52 as they may be collapsed in the direction shown by the arrow. The assembled pieces (60, 68) may be collapsed in different manners as well.

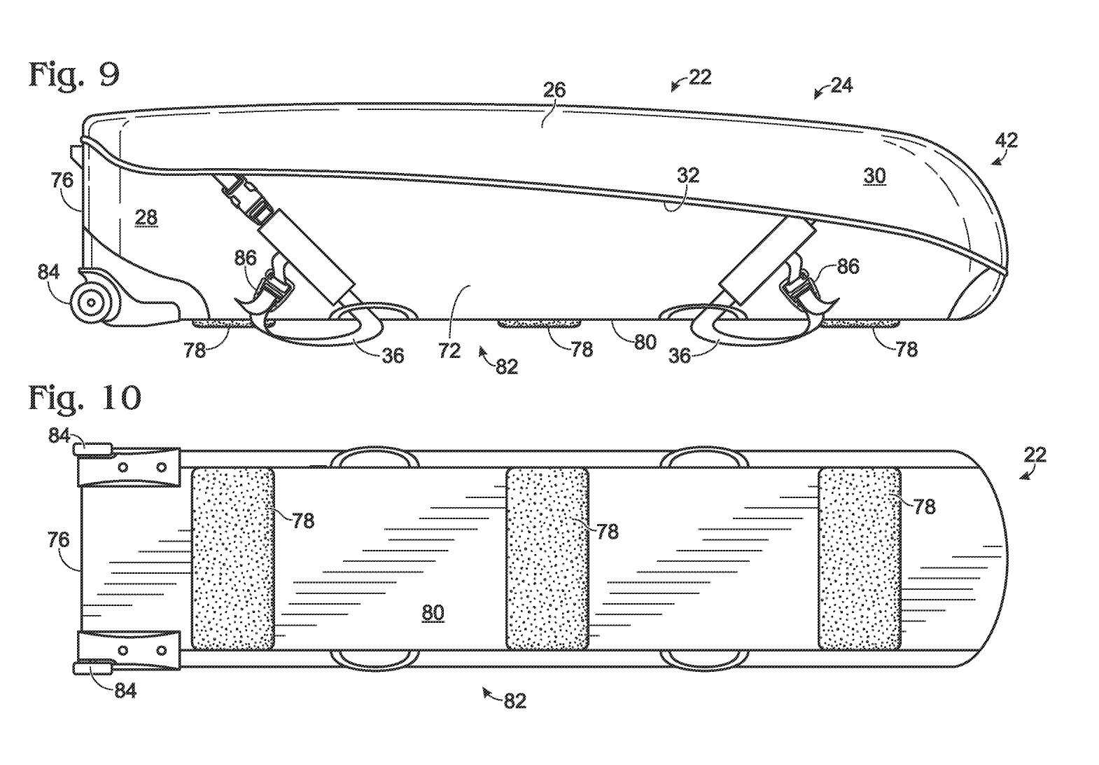

One concern with securing objects such as cargo bags onto the top of a vehicle, particularly when there is no roof rack and the cargo bag is being secured directly to the vehicle roof, is that the roof may be damaged. Accordingly, in some embodiments, cargo bag 22 may be configured to avoid damaging roof 14. For example, in FIGS. 9 and 10, cargo bag 22 includes at least one pad 78 on the bottom 80 of container portion 24. Pad 78 may be constructed of foam or other various soft and/or compliant materials that prevent other portions of cargo bag 22 from contacting and/or damaging roof 14. In FIGS. 9 and 10, pad 78 is one of a series of pads 82 positioned along bottom 80 of container portion 24 to protect roof 14 of the vehicle. This is particularly helpful in the embodiments of FIGS. 9 and 10, which include one or more wheels 84 at one end of bottom 80 of container portion 24. Series of pads 82 effectively prevent wheel 84 from contacting roof 14 of vehicle 10.

Referring now to FIGS. 11 and 12, cargo bag 22 may include one or more buckles 86 for securing one end of strap 36 to container portion 24. Each buckle 86 includes hook 88 which is usable to secure one end of strap 36 to fixed loop 90 on container portion 24. Buckles 86 also may be usable to secure one end of strap 36 to other straps or members that are secured to various parts of container portion 24. Buckles 86 (and more particularly, hooks 88) may be constructed at least partially out of particularly strong or reinforced material, such as metal. Each buckle 86 may also include a buckle portion 92 through which strap 36 may be fed and its tension adjusted.

In some embodiments, such as those shown in FIGS. 1 and 12, strap 36 may be securable to container portion 24 in a manner that straddles a corner 94 of container portion 24. This way, strap 36 may be used alternatively to secure container portion 24 to crossbar 16 (see FIG. 1) or a side rail of vehicle roof rack 12.

The various structural members disclosed herein may be constructed from any suitable material, or combination of materials, such as metal, plastic, nylon, plastic or any other materials with sufficient structural strength to withstand the loads incurred during use. Materials may be selected based on their durability, flexibility, weight, and/or aesthetic qualities.

Although the present disclosure has been provided with reference to the foregoing operational principles and embodiments, it will be apparent to those skilled in the art that various changes in form and detail may be made without departing from the spirit and scope of the disclosure. The present disclosure is intended to embrace all such alternatives, modifications and variances. Where the disclosure recites “a,” “a first,” or “another” element, or the equivalent thereof, it should be interpreted to include one or more such elements, but neither require nor exclude two or more such elements. Further, ordinal indicators, such as first, second, or third for identified elements are used to distinguish between the elements; they do not indicate a required or limited number of such elements, and do not indicate a particular position or order of such elements unless otherwise specifically stated. Any aspect shown or described with reference to a particular embodiment should be interpreted to be compatible with any other embodiment, alternative, modification, or variance.

We claim:

1. A cargo bag mountable on a roof rack of a vehicle and comprising:
a container portion constructed at least partially of textile;
a strap for securing the container portion to the roof rack; and
a structure adapted to provide shape to the container portion regardless of whether cargo is stored within the container portion.

2. The cargo bag of claim 1, wherein the structure includes a semi-rigid elongate member.

3. The cargo bag of claim 2, where the semi-rigid elongate member is pre-shaped into a frame that maintains the shape of the container portion.

4. The cargo bag of claim 3, wherein the frame includes a first portion secured to a base of the container portion and a second portion secured to a closure of the container portion, the second portion being biased away from the first portion so that the closure of the container portion is biased to an open position when unsecured from the base.

5. The cargo bag of claim 1, wherein the structure includes foam padding with a contracted configuration, in which the structure is collapsed, and an expanded configuration in which the structure provides the shape to the container portion.

6. The cargo bag of claim 5, wherein the foam padding is contained within an airtight chamber, and a valve is manipulable between an open position, in which gas is permitted to pass in or out of the airtight chamber, and a closed position.

7. The cargo bag of claim 6, wherein the foam padding is biased towards the expanded configuration so that when the foam padding is in the contracted configuration, the valve can be manipulated to the open position to permit gas to enter the airtight chamber, thereby permitting the foam padding to expand to provide the shape to the container portion.

8. The cargo bag of claim 6, wherein the airtight container is formed with laminate on the surface of the foam padding.

9. The cargo bag of claim 5, wherein the foam padding includes first and second pieces of foam padding, wherein the first piece includes a bottom portion for lining a floor of the container portion and a top portion for lining a closure of the container portion, and the second piece includes side portions for lining sides of the container portion and a back portion for lining a back of the container portion.

10. The cargo bag of claim 1, further comprising a pad positioned on a bottom of the container portion to protect a roof of the vehicle.

11. The cargo bag of claim 10, wherein the pad is one of a series of pads positioned along the bottom of the container portion to protect the roof of the vehicle.

12. The cargo bag of claim 11, further comprising a wheel at one end of the bottom of the container portion, wherein the series of pads prevent the wheel from contacting the roof of the vehicle.

13. The cargo bag of claim 1, further comprising a buckle with a metal hook for securing one end of the strap to the container portion.

14. The cargo bag of claim 1, wherein the strap is securable to the container portion to straddle a corner.

15. The cargo bag of claim 2, wherein the semi-rigid elongate member is removable from the container portion to make the container portion collapsible.

16. A cargo bag mountable on the roof of a vehicle, comprising:
a container portion;
a strap for securing the container portion to the roof; and
a pad positioned on a bottom of the container portion to protect the roof.

17. The cargo bag of claim 16, wherein the pad is one of a series of pads positioned along the bottom of the container portion to protect the roof of the vehicle.

18. The cargo bag of claim 17, further comprising a wheel at one end of the bottom of the container portion, wherein the series of pads prevent the wheel from contacting the roof of the vehicle.

19. The cargo bag of claim 18, further comprising:
foam padding contained within an airtight chamber, the foam padding having a contracted configuration and being biased to an expanded configuration in which the foam padding provides the shape to the container portion; and
a valve that is manipulable between an open position in which gas is permitted to pass in to or out of the airtight chamber and a closed position.

20. A cargo bag mountable on the roof of a vehicle, comprising:
a container portion constructed at least partially of a textile;
a strap for securing the container portion to the roof;
a pad positioned on a bottom of the container portion to protect the roof; and
a semi-rigid elongate member pre-shaped into a frame that maintains the shape of the container portion regardless of whether cargo is stored in the container portion.
